(19) United States
(12) Patent Application Publication
(10) Pub. No.: US 2010/0180834 A1
(43) Pub. Date: Jul. 22, 2010

(54) HEAT EXCHANGER

(75) Inventor: Mauro Ramazzotto, Schio (IT)

Correspondence Address: CONNOLLY BOVE LODGE & HUTZ LLP, 1875 EYE STREET, N.W., SUITE 1100, WASHINGTON, DC, 20006, US

(73) Assignee: Metal Brain, LLC, Miami, FL (US)

(21) Appl. No.: 12/664,795

(22) PCT Filed: Jun. 25, 2008
(86) PCT No.: PCT/IB2008/052548

§ 371 Date: Dec. 15, 2009

(30) Foreign Application Priority Data
Jun. 26, 2007 (IT) TV2007A000115

(51) Int. Cl. F24H 1/00; F28F 3/12; B23P 15/26

(52) U.S. Cl. 122/13.01; 165/168; 29/890.038

(57) ABSTRACT

Heat exchanger (1) comprising at least a heat exchange element (10), made of a plate (20) that is folded along at least one predefined folding plane (4), first portions (31,32) of said plate (20) facing one another at a same internal surface of said plate (20) and defining an internal volume (500) of said heat exchange element (10), separated first ducts (12) being provided in said internal volume (500) for the circulation of a primary fluid in said heat exchange element (10).

The present invention relates to a heat exchanger for boilers for civil and industrial use. In particular, the present invention relates to a heat exchanger with improved heat exchange efficiency, reduced size, and easier industrial production.

As is commonly known, boilers are thermal devices used for the production of hot service water to be used in either heating circuits or for personal use.

A boiler usually comprises a combustion chamber with a heat exchanger housed nearby, which is commonly referred to as “primary heat exchanger”.

A primary heat exchanger usually comprises a series of parallel pipes positioned transversally to the flow of the exhaust fumes leaving the combustion chamber. These ducts carry the boiler's service water inside and are fanned by the exhaust fumes on the outside. Through convection-conduction heat exchange, the heat of the exhaust fumes is transferred to the service water.

The primary heat exchanger's pipes are generally provided with fins protruding outwards, which improve the transmission of heat from the exhaust fumes to the service water by increasing the thermal exchange surface area. The fins can be mounted on or welded to the external surfaces of the primary heat exchanger's ducts or originally built into the same.

As is also known, downstream the primary heat exchanger, the exhaust fumes still possess considerable residual heat that can advantageously be recovered in order to pre-heat the primary heat exchanger's inlet water.

This enables a reduction in the fuel consumed thanks to the reduction of the thermal gradient necessary, at equal boiler service water final temperature required.

In order to recover residual heat, in some types of boiler such as condensation boilers, for example, devices known as “heat recovery devices” have traditionally been used.

These usually comprise heat exchangers, also known as “secondary heat exchangers”, positioned inside the boiler along the route used for the discharge of the exhaust fumes outwards.

In some widely known technical solutions, a secondary heat exchanger is composed of a series of pipes, often provided with fins. In this case, the energy exchange between the exhaust fumes and the service water occurs in a similar way as the one described for the primary heat exchanger.

Alternative technical solutions, such as the so-called “plate-type heat exchangers” juxtapose a number of different shaped plates in order to form various distribution chamber units. The chambers in each unit are respectively traversed by both the exhaust fumes and the service water. These chambers are alternately connected with one another in order to ensure both the fluids circulation and an effective thermal exchange between said fluids.

Heat exchangers according to the prior art have certain limits linked to their construction and assembly, and are fairly cumbersome, especially when the fins are applied to the pipes and/or exhaust gas container casings or walls.

Their bulk puts significantly limits the design and definition of the layout of the boiler, which often requires laborious preliminary study.

Traditional type heat exchangers are also rather difficult to produce on industrial scale due to the relatively high number of parts (ducts or plates) to be assembled. This obviously also affects the costs of industrial production.

For the reasons above, the need for new heat exchangers that are economically advantageous, easily assembled, and compact in size is still widely felt.

Therefore, the main aim of the present invention is to provide an improved heat exchanger for boilers capable of overcoming the aforesaid drawbacks.

Within the scope of this aim, an object of the present invention is to provide a heat exchanger made with a relatively small number of easily assembled parts.

Another object of the present invention is to provide a heat exchanger that is both highly reliable and ensures efficient thermal exchange between exhaust fumes and service water.

A further object of the present invention is to provide a heat exchanger that is easy to integrate and install in a boiler for domestic or industrial use.

Yet another object of the present invention is to provide a heat exchanger with a relatively simple structure that is also relatively easy to produce on industrial scale at competitive costs.

This aim and these objects, together with the other aims that will emerge from the description that follows and from the attached drawings, are achieved according to the present invention by a heat exchanger for boilers according to the following independent claim 1.

The heat exchanger, according to the invention, offers notable advantages, especially in regard to the reduction of dimensions, the efficiency of thermal exchange, and the ease of assembly.

The heat exchanger, according to the invention, is provided with heat exchange elements having a structure formed by a plate that is folded along a predefined folding plane. The plate is folded in such way that first portions of said plate face one another at a same internal surface and define a volume, into which a number of first ducts is formed for the circulation of a primary fluid in the above-mentioned heat exchange element.

In order to further reduce dimensions while improving thermal efficiency exchange at the same time, the heat exchanger according to the invention also features improved heat transmission means, which in association with the heat exchange elements allow a significant increase in the heat exchange surface area available, with a noteworthy improvement in the transmission of heat among the fluids circulating in the heat exchanger.

The heat transmission means may be easily assembled with said heat exchange elements or preferably they may be obtained from second portions of the heat exchange elements, being thereby fully integral with the structure of said heat exchange elements. Thus, it is possible to provide a heat exchanger with an extremely compact structure, an elevated flexibility in design and easy assembly.

Simple manufacturing methods can be adopted for the industrial production of both the heat exchange elements and the heat exchanger itself.

Further characteristics and advantages of the invention can be more clearly perceived with reference to the description provided below and the following drawings enclosed for purely illustrative yet non-limiting purpose:

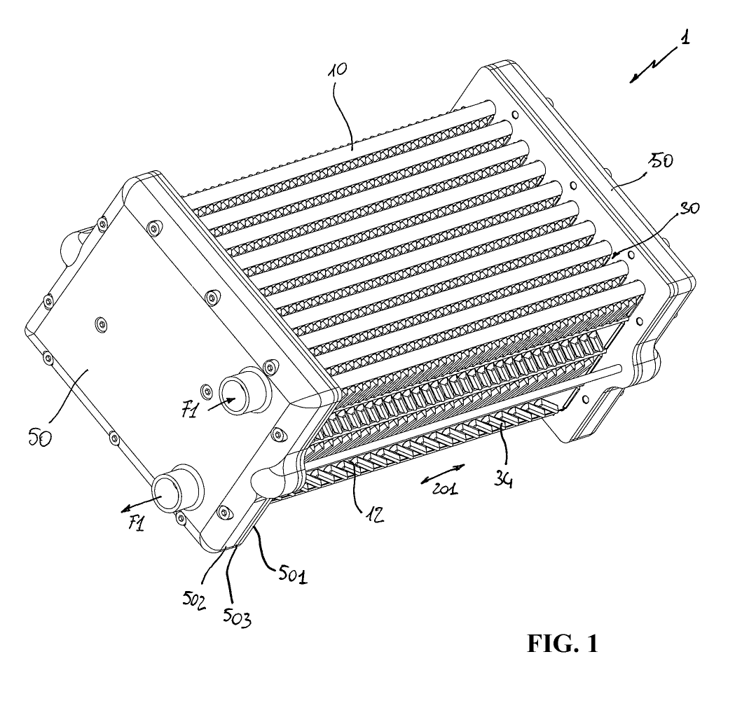

FIG. 1 schematically shows a perspective view of a first embodiment of the heat exchanger according to the invention; and

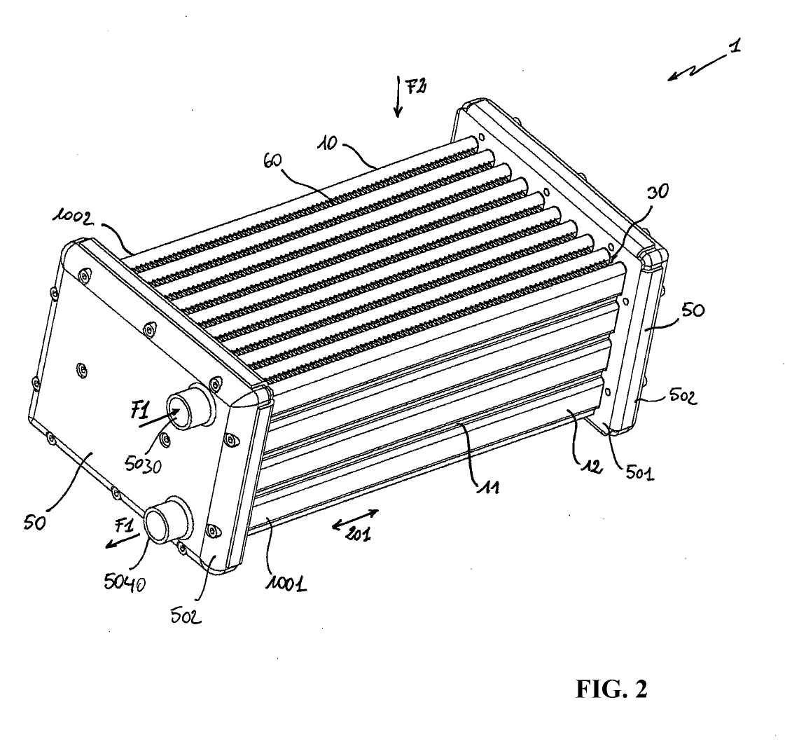

FIG. 2 schematically shows a perspective view of a further embodiment of the heat exchanger according to the invention; and

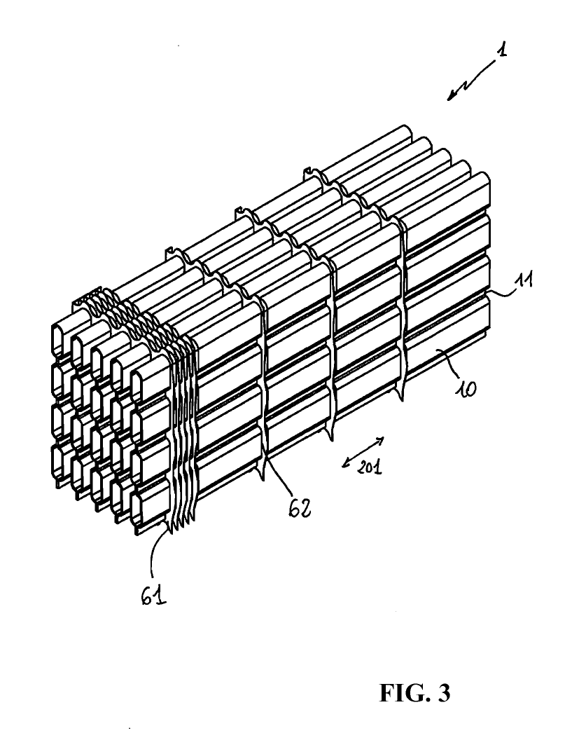

FIG. 3 schematically shows a partial perspective view of a further embodiment of the heat exchanger according to the invention; and

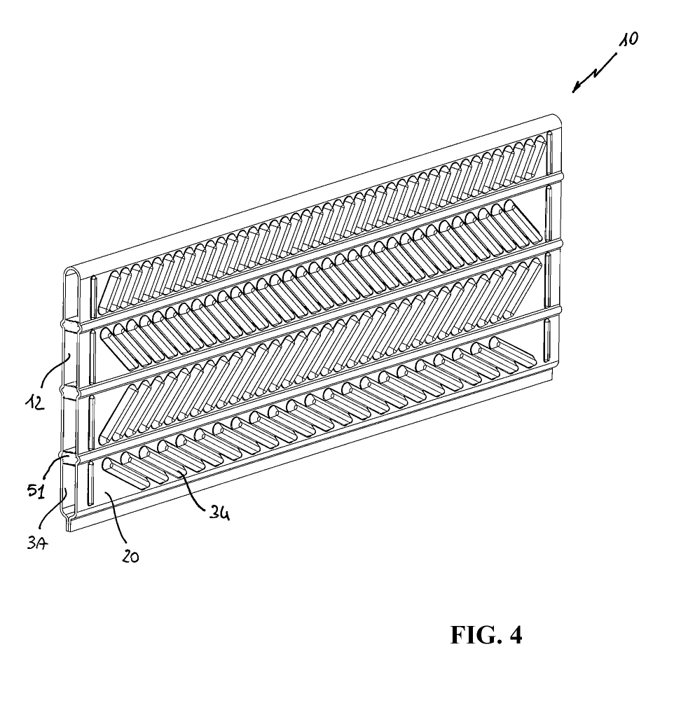

FIG. 4 schematically shows a perspective view of a heat exchange element in the heat exchanger of FIG. 1; and

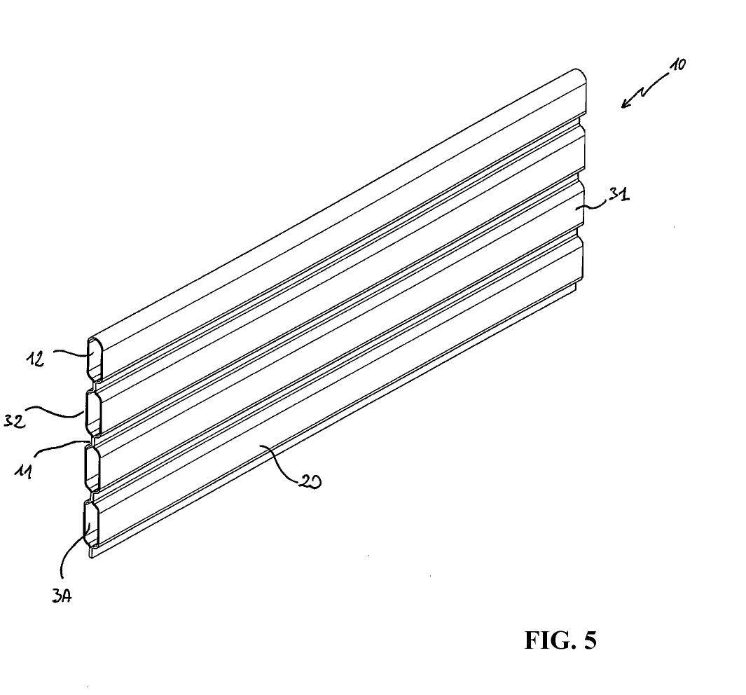

FIG. 5 schematically shows a perspective view of a heat exchange element in the heat exchanger of FIG. 2; and

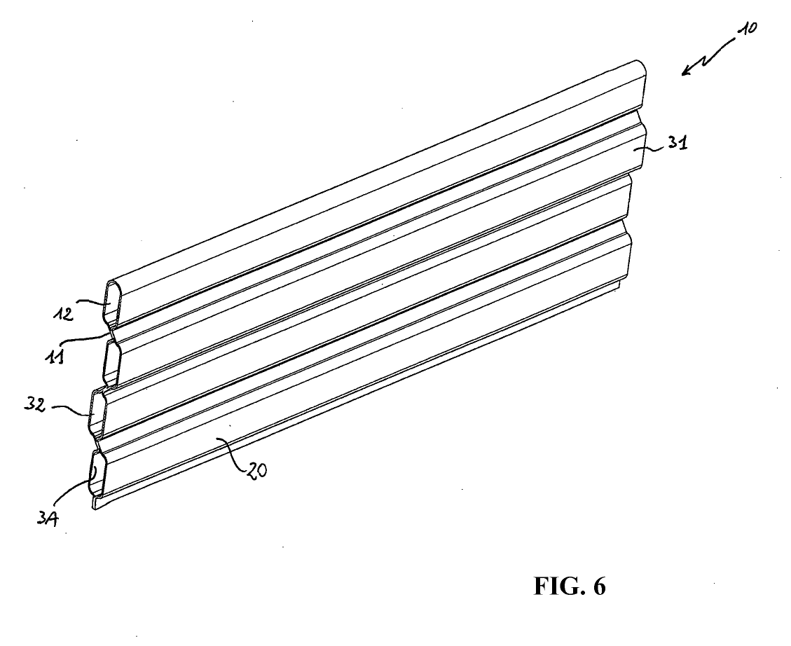

FIG. 6 schematically shows a perspective view of a heat exchange element in a further embodiment of the heat exchanger according to the invention; and

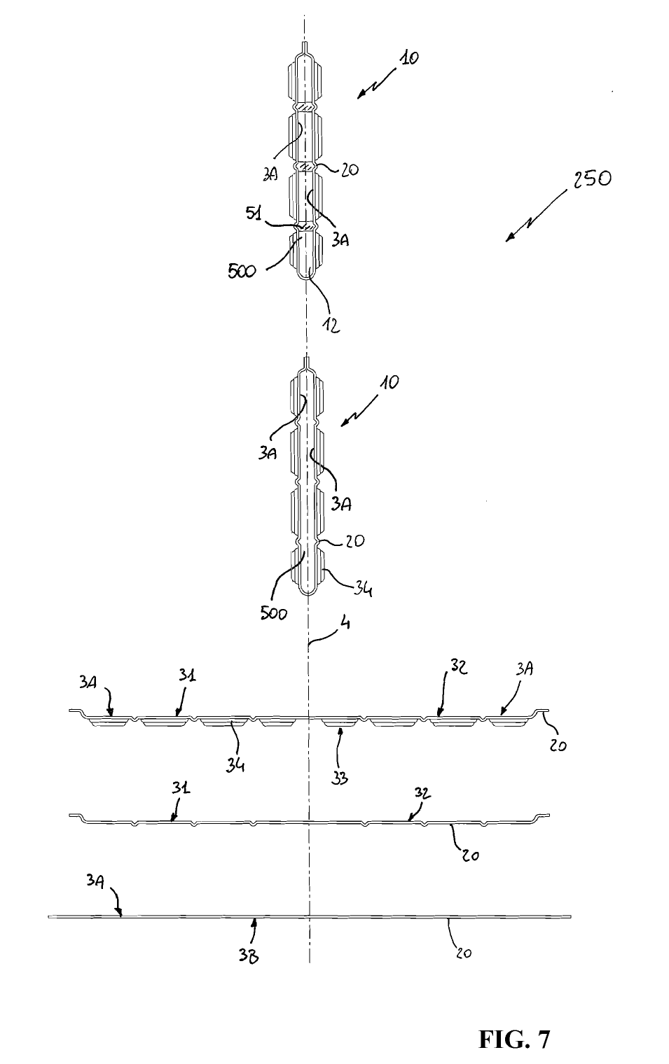

FIG. 7 schematically shows some steps of a method for manufacturing the heat exchange element of FIG. 4; and

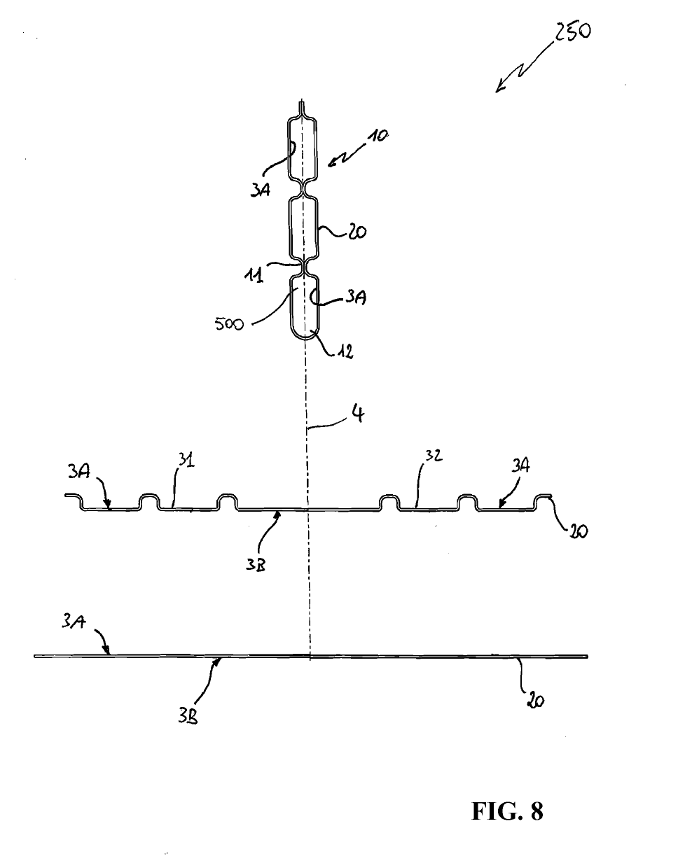

FIG. 8 schematically shows some steps of a method for manufacturing the heat exchange element of FIG. 5; and

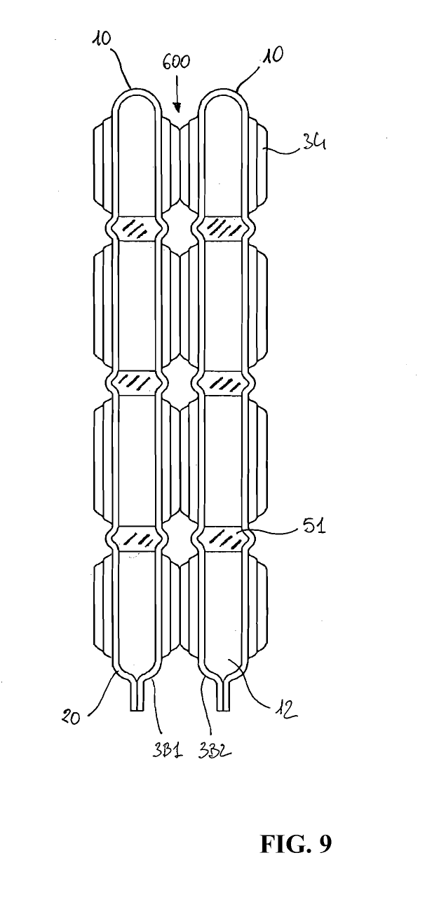

FIG. 9 schematically shows a cross-sectional view of an assembly composed of a pair of heat exchange elements in the heat exchanger of FIG. 1; and

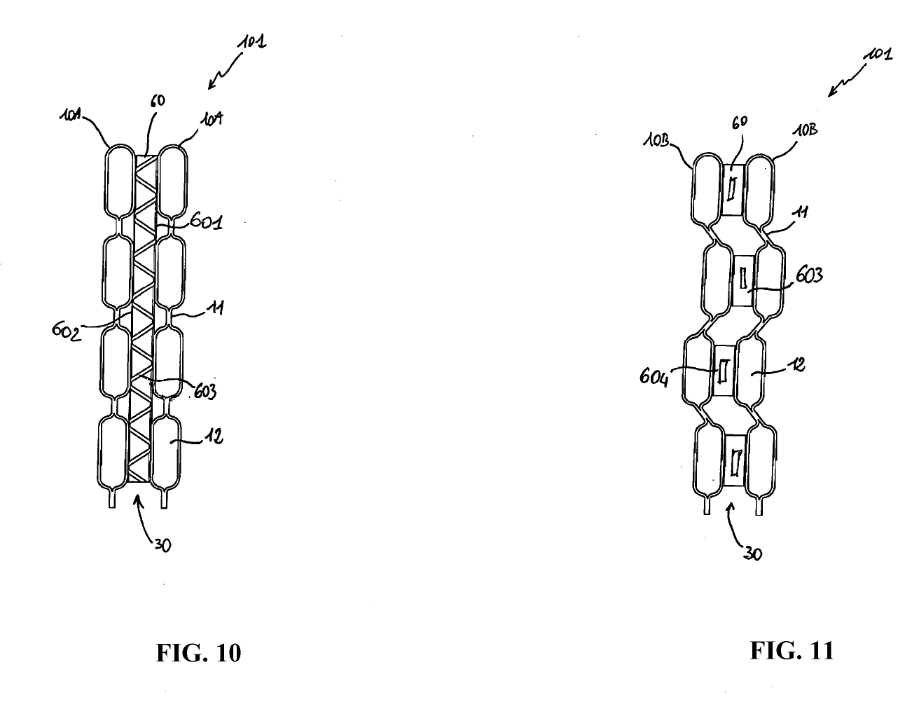

FIG. 10 schematically shows a cross-sectional view of an assembly composed of a pair of heat exchange elements and a corrugated metal sheet in the heat exchanger of FIG. 2; and

FIG. 11 schematically shows a cross-sectional view of an assembly composed of a pair of heat exchange elements and a number of corrugated metal sheets in a further embodiment of the heat exchanger, according to the invention; and

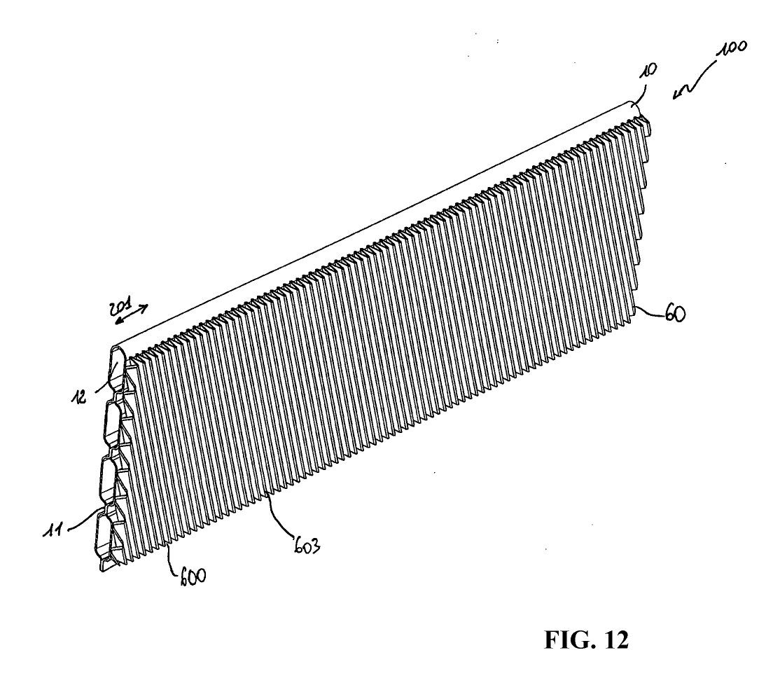

FIG. 12 schematically shows a perspective view of an assembly composed of a heat exchange element and a corrugated metal sheet in the heat exchanger of FIG. 2; and

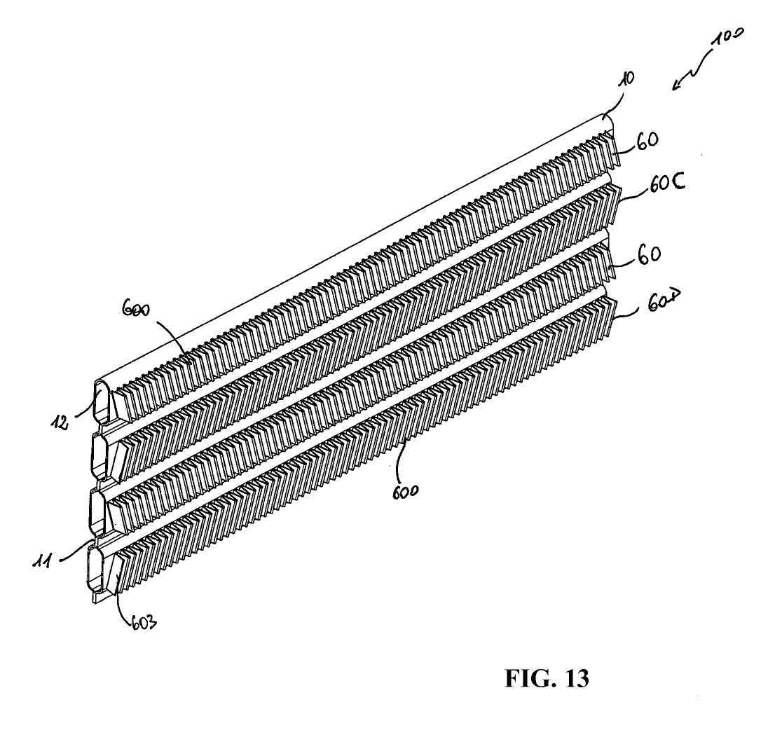

FIG. 13 schematically shows a perspective view of an assembly composed of a heat exchange element and a number of corrugated metal sheets in a further embodiment of the heat exchanger, according to the invention;

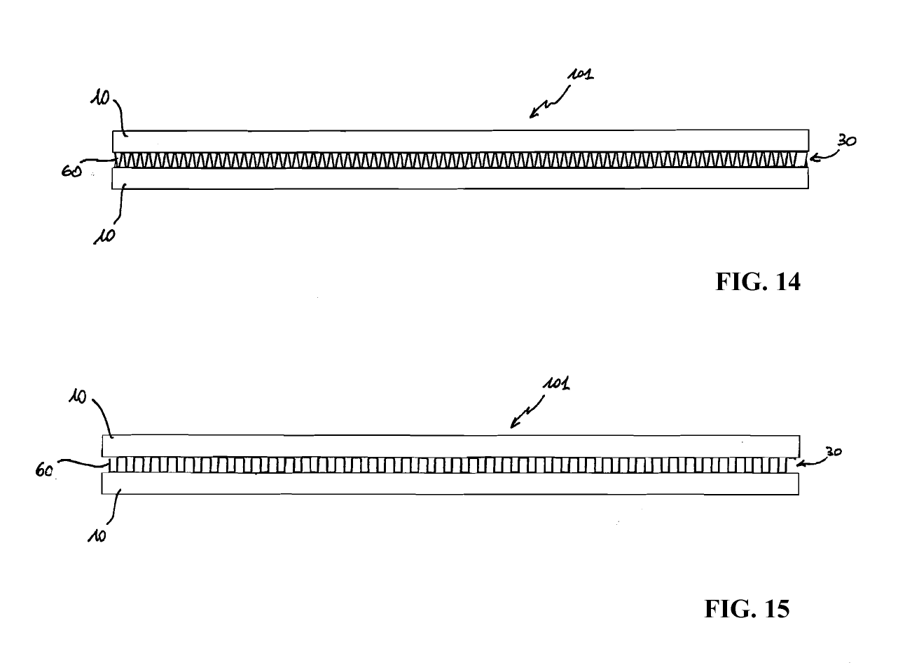

FIG. 14 schematically shows a view from above of an assembly composed of a pair of heat exchange elements and a corrugated metal sheet in the heat exchanger of FIG. 2; and

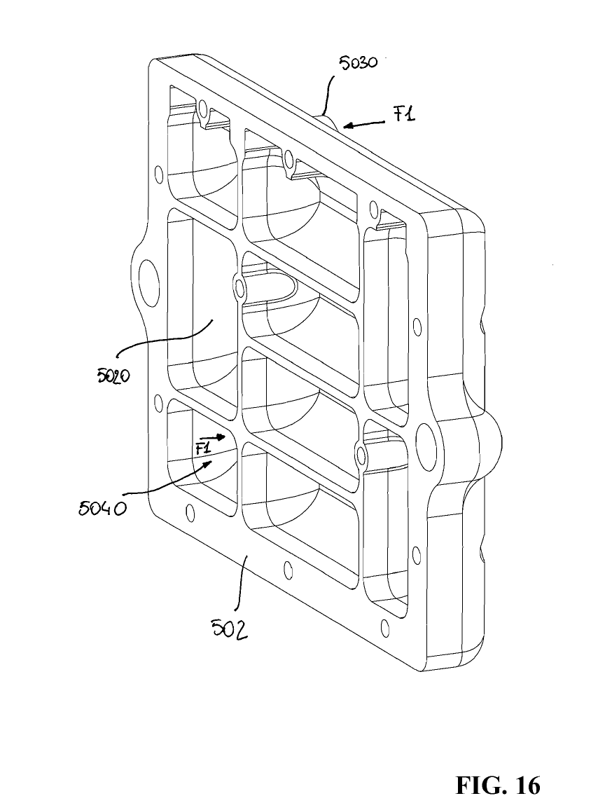

FIG. 15 schematically shows a view from above of an assembly composed of a pair of heat exchange elements and a corrugated metal sheet in a further embodiment of the heat exchanger, according to the invention; and

FIG. 16 schematically shows a partial perspective view of a head portion of the heat exchanger shown in FIG. 1;

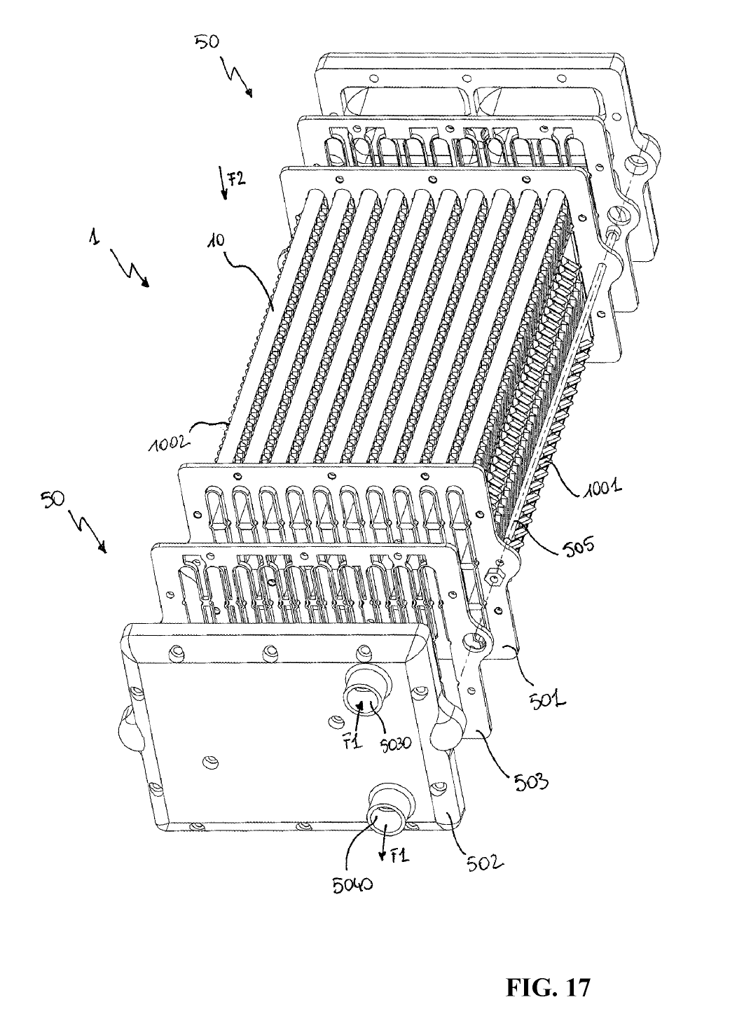

FIG. 17 schematically shows an exploded view of the heat exchanger shown in FIG. 1.

With reference to the aforesaid figures, the heat exchanger for boiler 1, according to the present invention, comprises one or more heat exchange elements 10.

The heat exchange elements 10 comprise a plate 20 equipped with a first shaped portions 31 and 32.

The plate 20 is folded along at least one pre-defined folding plane 4 in such way that the first portions 31-32 face one another in regard to a same internal surface area 3A of the plate 20. The folded first portions 31-32 define an internal volume 500 of the heat exchange element, in which separated first ducts 12 are provided in said internal volume for the circulation of a primary fluid F1, which is advantageously the boiler service water.

According to an embodiment of the present invention (see e.g. FIGS. 2, 5, 8) the shaped portions 31-32 overlap at least partially and form one or more connecting portions 11, in each heat exchange element 10. The connecting portions 11 advantageously delineate one or more of these ducts 12 and strengthen the structure of the heat exchange element 10.

According to another preferred embodiment of the present invention (see e.g. FIGS. 1, 4, 7, 9) one or more separation elements 51 are positioned in the internal volume 500 between the first portions 31, 32, so as to define one or more of the first ducts 12.

Preferably, the first ducts 12 run along a main longitudinal direction 201, substantially parallel to the folding plane 4.

The first ducts 12 are advantageously positioned parallel to one another, preferably according to a same laying plane parallel to the folding plan 4. In this way, a series of ducts 12 with a substantially prismatic configuration comes to be formed in the heat exchanger 1 (see e.g. FIGS. 4-5).

As an alternative, the first ducts 12 can be arranged according to a staggered configuration (FIG. 6) and positioned parallel to one another along plural laying planes, which are all parallel to the folding plane 4. In this case, the connecting portions 11 are developed in flat or curved surfaces at an angle to the folding plane 4.

The first ducts 12 have preferably rectangular or oval shape but they can obviously be given any other shape required (circular, for example). Also the number and size of the ducts 12 for each heat exchange element 10 can be varied as necessary.

The heat exchange elements 10 are advantageously made in metal and can advantageously comprise a substrate in steel, stainless steel, copper, aluminum, or iron. This substrate is advantageously coated on its external surface 3B (FIGS. 7-8) by one or more layers of metal material with melting temperatures lower than those of the substrate.

A stainless steel substrate coated with one or more layers of a nickel-based alloy can be used, for example. As an alternative, the substrate above can be coated with one or more layers of the appropriate metal brazing paste or with one or more of the appropriate types of metal brazing powder.

The heat exchange elements 10 have a structure that can be easily produced on industrial scale by means of a manufacturing method 250, which is schematically shown in two possible variants in FIGS. 7-8.

Said manufacturing method preferably comprises an initial step of providing a plate 20, for example by one or more blanking and/or cold deforming operations on a metal sheet.

The manufacturing method 250 also advantageously comprises a second step of folding of the plate 20 along a pre-defined folding plane 4.

In FIGS. 7-8, the folding plane 4 coincides with one of the median planes of the plate 20. The plate 20 can be folded along different folding planes as required.

In any case, the folding of the plate 20 allows first portions 31-32 of the plate 20 to be juxtaposed at a same internal surface 3A of the plate 20, so as to define an internal volume 500 of the heat exchange element 10.

Finally, the method 250 comprises the step of providing separated first ducts 12 in the internal volume 500 for the circulation of the primary fluid F1.

According to a first possible alternative of the manufacturing method 250 (FIG. 7), this last step comprises the positioning one or more separation elements 51 between the shaped portions 31, 32, so as to define one or more first ducts 12 in the internal volume 500.

According to another alternative (FIG. 8), the first portions 31-32 are overlapped at least partially at one or more connecting portions 11, which define one or more ducts 12 in the internal volume 500.

In the construction of the heat exchanger 1, numerous heat exchange elements 10 are aligned together side by side in order to create one or more hollow spaces 30 for the passage of a second fluid F2, which is advantageously composed of the exhaust fumes of the combustion chamber.

These hollow spaces 30 advantageously house heat transmission means, which improve the efficiency of thermal exchange between the fluids F2-F1 circulating in the heat exchanger 1.

These heat transmission means may comprise a number of traditional type fins that are operatively associated with each heat exchange element 10 or each pipe 12. Said fins can be constructed and installed by commonly-known processes.

In the embodiment of FIG. 3, the fins are formed from sheets 61 having shaped openings 62 inside of which the heat exchange elements 10 are inserted. The sheets 61 may be worked through appropriate cold deforming processes from a metal strip and are advantageously positioned in substantially perpendicular direction to the main direction of development 201 of the heat exchange elements 10, in such way as to maximize the amount of surface area available for thermal exchange. The joining of the sheets 61 to the heat exchange elements 10 can be made by brazing, soldering, or other commonly-known processes.

As an alternative, the above-mentioned heat transmission means comprise one or more foils 60 at least partially corrugated (see e.g. FIGS. 2, 4, 10-14).

The foils 60 are advantageously positioned in the hollow spaces 30. Each heat exchange element 10 can be associated with only one corrugated foil 60 as shown in FIG. 12.

Alternatively, as shown in FIG. 13, each heat exchange element 10 can be associated with more than one foil 60, each of which is preferably associated to one of the ducts 12.

Advantageously, the corrugations of the foils 60 are positioned along one or more predefined directions, so as to define a number of ducts 600 for the circulation of the second fluid F2 in the hollow spaces 30. This offers the significant advantage of permitting a remarkable increase in the amount of surface area available for thermal exchange without increasing overall dimensions.

The corrugated foils 60 can be given a transversal profile that substantially reproduces the periodic type wave form, such as in triangular or square shape (FIGS. 14-15).

Profiles other than those illustrated can obviously be adopted as required by the amount of thermal exchange desired.

It is also possible to use profiles with a combination of wave forms (such as sinusoidal) appropriately shifted in such way as to make the passage route of the exhaust fumes F2 inside the hollow spaces 30 more complex, thus increasing turbulence.

The pitch or period of the profile of each foil 60 can be defined on the basis of the position of the foil itself, or in other words, as a function of the temperature gradient of the exhaust fumes F2. By way of example, the profile of a foil 60C positioned near the combustion chamber (not shown) can advantageously be provided with a larger pitch than a foil 60D located in a more distant position.

In order to increase the turbulence of the exhaust fumes F2 in the hollow spaces 30, the foils 60 can comprise near the lateral surfaces 603 (FIG. 11) turbulence windows 604 appropriately shaped and provided with raised edges (not shown) compared to the surfaces 603.

The corrugated foils 60 have an extremely simple structure, and for this reason they can be easily produced on industrial scale through the appropriate processes of blanking and/or cold deforming of a metal strip.

As required by need, the technical solutions described above can obviously be combined when creating the above-mentioned heat transmission means.

The corrugated foils 60 can be advantageously produced in metal and feature a substrate subjected to the appropriate plating technique using layers of metal with low melting temperature or appropriately coated with brazing paste near the external contact surfaces 601 and 602 (FIG. 10).

The use of a metal substrate plated with materials with low melting temperatures or coated with brazing paste for the heat exchange elements 10 and the foils 60 significantly facilitates the assembly of such components. Simple brazing or soldering operations, in fact, can be used to fasten the foils 60 to the external surfaces 3B of the heat exchange elements 10.

According to a preferred embodiment of the present invention, the heat transmission means are formed by second portions 33 of the plates 20 of the heat exchange elements 10.

The second portions 33 comprise corrugations 34 at the external surface 3B of the plates 20, which are thus fully integral with them.

Appropriate processes of blanking and/or cold deforming of a metal strip may be used to obtain the corrugations 34 from the portions 33 of the plate 20.

The corrugations 34 are preferably oriented along one or more predefined directions, so as to define second ducts 600 along the hollow spaces 30 for improving the circulation of the second fluid F2.

Preferably, the corrugations 34 at the external facing surfaces 3B1 and 3B2 of each couple of heat exchange elements 10 defining an intermediate hollow space 30 are oriented, so as to be juxtaposed along said hollow space and define second ducts 600 for the circulation of the second fluid F2 in said hollow space.

In light of the above, it is apparent how heat exchanger 1 can be produced at industrial level through a simple manufacturing method.

Such a manufacturing method preferably comprises a first step of providing of a plurality of heat exchange elements 10.

According to the invention, each of said heat exchange elements 10 comprises a plate 20 that is folded along at least one pre-defined folding plane 4 with first portions 31, 32 of said plate facing one another at a same internal surface 3A and defining an internal volume 500 of said heat exchange element, separated first ducts 12 being provided in said internal for the circulation of a primary fluid F1.

One of the alternatives of the manufacturing method 250 described above may be adopted for the execution of this first step.

Then, the assembly of the heat exchanger 1 comprises the repeated juxtaposition of a heat exchange element 10 by positioning the heat exchange elements 10 side by side, so as to define one or more hollow spaces 30 between the heat exchange elements 10 and allow the passage of the secondary fluid F2.

The assembly of the heat exchanger 1 comprises the step of providing the described heat transmission means for the second fluid F2 at the hollow spaces 30.

This last step may comprise the phase of associating one or more heat exchange elements 10 with one or more corrugated foil 60.

The various components can be assembled in any time sequence as required. For example, assemblies 100, composed of a heat exchange element 10 and the respective foils 60, or other assemblies 101, composed of a pair of heat exchange elements 10 between which at least one foil 60 can first be assembled separately and then assembled together in modular fashion. Alternatively, the assembly of the heat exchanger 1 comprises the repeated juxtaposition of a heat exchange element 10 and one or more corrugated foil 60 brazed or soldered together.

As a further alternative, the step of providing the heat transmission means may comprise the phase of associating the heat exchange elements 10 with one or more sheets 61.

Preferably, the mentioned heat transmission means are provided directly during the blanking and/or cold deforming process of the plate 20, in which the corrugations 34 may be formed at the second portions 33 of the plate 20.

Preferably near their ends, the heat exchange elements 10 are operatively connected to a pair of head portions 50, suited to maintain the assembly of the heat exchange elements 10 while ensuring the circulation of the service water F1 at the same time.

Each head portion 50 advantageously comprises a terminal flange 501 that keeps the heat exchange elements in position while ensuring a hydraulic seal between the F1 and F2 fluid circuits. The terminal flange 501 is fastened to a manifold 502, after first inserting a sealing gasket 503. The manifold 502 comprises a series of internal pipes 5020 that create a circuit for the circulation of the fluid F1 between the ducts 12. The fastening of the terminal flanges 501 to the respective manifolds 502 can be made by screwing or seaming.

Near one of the manifolds 502, openings 5030 and 5040 are advantageously obtained for the inlet and outlet of the fluid F1 into/out of the heat exchanger 1. As an alternative, the openings 5030 and 5040 could be made in the manifolds 502 for different portions of head 50. Advantageously, the manifolds 502 are made in composite plastic material. This allows a further decrease in the total weight of the heat exchanger 1.

The assembly between the head portions 50 and the heat exchange elements 10 is preferably fixed by tension rods 505, which are positioned laterally and preferably also centrally and which extend along the entire length of the heat exchanger 1 from a head portion 50 to another.

It should be noted that the heat exchanger 1 does not require external casings or lateral walls for the correct containment of the exhaust fumes. This function can, in fact, be performed by the heat exchange elements 1001 and 1002 that laterally delimit the volume traversed by the exhaust fumes F2 without requiring the use of any other elements.

It is evident that the heat exchanger 1 presents a substantially modular structure that can be easily sized to each heat exchanger application need with regard to both the dimensions of the first ducts 12 and the number of the ducts 12 overlapping one another in the same heat exchange element 10, and the number of heat exchange elements 10 paired together.

The heat exchanger 1 easily finds application as a primary-type heat exchange device, such as in a condensation boiler, for example, in which case it can be combined with a combustion chamber (non shown), provided, for example, with a total pre-mixing burner suited to the production of a downward oriented flame. This combustion chamber can be made using suitable panels in ceramic and/or refractory material or can also consist of hollow walls inside of which the boiler's service water circulates.

This structural modularity, which is remarkably flexible in terms of the design and dimensions of the heat exchanger 1, permits easy use also as a secondary heat exchanger, such as in a boiler for latent exhaust gas heat recovery, for example.

The heat exchanger 1, according to the present invention, allows the achievement of the aims specified above.

The heat exchanger 1 has an extremely simple structure that permits easy and economical industrial production. The modularity of the structure also permits the easy sizing of the heat exchanger to every type of need in the system in which it is inserted.

The heat exchanger 1 ensures efficacious thermal exchange between exhaust fumes and service water thanks to the relatively elevated thermal exchange surface area that can be obtained by the mentioned heat transmission means, for example.

At the same time, thanks to its extremely compact structure, the heat exchanger 1 has relatively reduced overall dimensions that considerably facilitate the design of the boiler in which the heat exchanger must be inserted.

This simplified structure allows a reduction in production costs compared to those of traditional heat exchangers.

1. Heat exchanger comprising at least a heat exchange element (10), characterized in that said heat exchange element comprises a plate (20) that is folded along at least one predefined folding plane (4), first portions (31, 32) of said plate facing one another at a same internal surface (3A) of said plate and defining an internal volume (500) of said heat exchange element, separated first ducts (12) being provided in said internal volume for the circulation of a primary fluid (F1) in said heat exchange element.

2. Heat exchanger, according to claim 1, characterized in that said first portions overlap at least partially at one or more connecting portions (11) of said heat exchange element, said connecting portions defining one or more of said ducts in said internal volume.

3. Heat exchanger, according to claim 1, characterized in that one or more separation elements (51) are positioned in said internal volume between said first portions, said separation elements defining one or more of said ducts.

4. Heat exchanger, according to claim 1, characterized in that said first ducts run parallel along a main longitudinal direction (201) that is substantially parallel to said folding plane.

5. Heat exchanger, according to claim 1, characterized in that it comprises heat transmission means for improving the heat transmission between a second fluid (F2) and said primary fluid.

6. Heat exchanger according to claim 5, characterized in that it comprises a plurality of heat exchange elements (10) that are positioned side by side, so as to form one or more hollow spaces (30) for the passage of said second fluid (P2) between said heat exchange elements, said heat transmission means being positioned at one or more of said hollow spaces.

7. Heat exchanger, according to claim 1, characterized in that said heat transmission means comprise one or more corrugated foils (60).

8. Heat exchanger, according to claim 7, characterized in that said corrugated foils have corrugations that are oriented along one or more predefined directions, so as to define along said hollow spaces second ducts (600) for the circulation of said second fluid.

9. Heat exchanger, according to claim 1, characterized in that said heat transmission means comprise metal sheets (61) provided with one or more shaped openings (62), said heat exchange elements (10) being accommodated in said shaped openings.

10. Heat exchanger, according to claim 1, characterized in that said heat transmission means comprise second portions (33) of the plates of said heat exchange elements, said second portions comprising corrugations (34) that are formed at an external surface (3B) of said plates.

11. Heat exchanger, according to claim 10, characterized in that said corrugations (34) are oriented along one or more predefined directions, so as to define along said hollow spaces second ducts (600) for the circulation of said second fluid.

12. A boiler for domestic or industrial use characterized in that it comprises a heat exchanger, according to claim 1.

13. A method for manufacturing a heat exchange element (10) for a heat exchanger (1) for boilers characterized in that it comprises at least the following steps:
providing a plate (20); and
folding said plate (20) along at least one pre-defined folding plane (4), so that first portions (31, 32) of said plate face one another at a same internal surface (3A) of said plate and define an internal volume (500) of said heat exchange element;
providing separated first ducts (12) in said internal volume for the circulation of a primary fluid (F1) in said heat exchange element.

14. A method, according to claim 13, characterized in that it comprises the step of positioning one or more separation elements (51) in said internal volume between said shaped portions, said separation elements defining one or more of said first ducts.

15. A method, according to claim 1, characterized in that it comprises the step of overlapping at least partially said first portions at one or more connecting portions (11) of said heat exchange element, said connecting portions defining one or more of said ducts in said internal volume.

16. A method for manufacturing a heat exchanger (1) characterized in that it comprises the following steps:
providing of a plurality of heat exchange elements (10), said heat exchange elements comprising a plate (20) that is folded along at least one pre-defined folding plane (4), first portions (31, 32) of said plate facing one another at a same internal surface (3A) of said plate and defining an internal volume (500) of said heat exchange element, separated first ducts (12) being provided in said internal for the circulation of a primary fluid (F1) in said heat exchange element; and
positioning said heat exchange elements side by side, so as to define one or more hollow spaces between said heat exchange elements for the passage of a secondary fluid (F2) in said heat exchanger; and
providing heat transmission means for said second fluid at said hollow spaces.

17. Heat exchanger, according to claim 2, characterized in that one or more separation elements (51) are positioned in said internal volume between said first portions, said separation elements defining one or more of said ducts.

18. Heat exchanger, according to claim 2, characterized in that said first ducts run parallel along a main longitudinal direction (201) that is substantially parallel to said folding plane.

19. Heat exchanger, according to claim 3, characterized in that said first ducts run parallel along a main longitudinal direction (201) that is substantially parallel to said folding plane.

20. Heat exchanger, according to claim 2, characterized in that it comprises heat transmission means for improving the heat transmission between a second fluid (F2) and said primary fluid.
